(19) United States
(12) Patent Application Publication
(10) Pub. No.: US 2010/0141852 A1
(43) Pub. Date: Jun. 10, 2010

(54) Distortion Corrected Improved Beam Angle Range, Higher Output Digital Luminaire System

(75) Inventors: Pavel Jurik, Postredni Becva (CZ); Martin Farnik, Postredni Becva (CZ)

Correspondence Address: HEINZ GRETHER PC;G2 Technology Law, P.O. Box 202858, AUSTIN, TX, 78720, US

(73) Assignee: ROBE LIGHTING S.R.O.

(21) Appl. No.: 12/329,019

(22) Filed: Dec. 5, 2008

(51) Int. Cl. H04N 3/26

(52) U.S. Cl. 348/745; 348/E03.048

(57) ABSTRACT

The described system 100 provides a digital luminaire 102 which provides optical distortion correction across a wide range variable beam luminaire using lower cost lighter, simpler more efficient higher output optical drives 106 resulting in luminaires 102 that generate higher light output 120-122-124 with lighter units at lower cost over a larger range of beam angles without image distortion.

### TECHNICAL FIELD OF THE INVENTION

The present invention generally relates to the field of entertainment lighting generally, and more specifically, to digital image lighting systems.

### BACKGROUND OF THE INVENTION

Luminaires with automated and remotely controllable functionality are well known in the entertainment and architectural lighting markets. Such products are commonly used in theatres, television studios, concerts, theme parks, night-clubs and other venues. A product will typically provide control over the pan and tilt functions of the luminaire allowing the operator to control the direction the luminaire is pointing and thus the position of the light beam on the stage or in the studio. Typically this position control is done via control of the luminaire's position in two orthogonal rotational axes usually referred to as pan and tilt. Many products provide control over other parameters such as the intensity, color, focus, beam size, beam shape and beam pattern. The beam pattern is typically provided by a stencil or slide called a gobo which may be a steel, aluminum or etched glass pattern. The products manufactured by Robe Show Lighting such as the ColorSpot 1200E are typical of the art.

It is also well known to utilize a video projection engine as the light source in such a luminaire so as to be able to project still and/or moving images and video as well as the simple images provided by the beam patterning gobos. The Digital Spot 5000DT from Robe Show Lighting is an example of such a product which are frequently referred to as digital luminaires.

These digital luminaires are commonly used in many different entertainment and commercial applications such as theatres, television studios, concerts, theme parks, night-clubs and other venues. The luminaires may be used to project content from video sources such as DVD players or video cameras or may project a video stream that is computer generated. A fully automated digital luminaire may be used as a highly flexible lighting instrument giving the user full control over the imagery, color, patterns and output of the luminaire.

In many cases the imagery used in these projectors is produced by a media server. A media server is usually a computer based system which allows the user to select a video image from an external library, manipulate and distort that image, combine it with other images and output the completed imagery as a video stream. Examples of some of the many different manipulations available might include image rotation & scaling, overlaying multiple images and color change.

It is also well known to use sophisticated optical systems within automated luminaires to give the user control of, amongst other parameters, the beam angle of the output and thus the size of the image projected onto a surface. This is commonly achieved either by using interchangeable fixed focal length lenses or through a variable focal length, or zoom lens. For example a zoom lens may be used which has a range of available output beam angles ranging from 20° to 30° allowing the user to change the projected image size by a factor of 1.5 to 1 as desired. Fixed focal length lenses may be provided in a wide range of focal lengths.

The design of very narrow beam angle (long focal length) lenses or zoom lenses with wide ranges is complex and difficult with goals that are often competing. For example, with a zoom lens, the user would like the zoom lens to simultaneously have a high zoom range (range of beam angles) while also having high efficiency so that the light is as bright as possible. Further it is important that the lens introduce minimal distortion to the image. Zoom lenses that provide wide ranges of focal length and fixed focal length lenses with extremely long or extremely short focal lengths will often introduce optical distortions to the image such as pincushion and barrel distortion described below. For video projection systems lens designs are selected or designed to that minimize these distortions. This is because low optical distortion is more critical in video protection then light output.

Since generally wider ranges of beam angle lens designs tend to create more optical distortion, video projection systems lens designs are selected or designed with relatively low ranges of beam angles. Again this is because low optical distortion is more critical having a wide range of beam angles available.

In addition to having lower light output lens systems that have lower optical distortion are much more expensive, heavier and more difficult to manufacture.

There is a need therefore for digital lighting systems which provide wider ranges of beam angles while minimizing image distortion and maximizing light output.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a prior art digital luminaire system;

FIG. 2 illustrates a digital luminaire system with a larger range of beam angles while maximizing output and minimizing image distortion.

FIG. 3 illustrates an alternative embodiment of a digital luminaire system with multiple digital luminaires;

FIG. 4 illustrates a digital luminaire as an embodiment of the invention;

FIG. 5 illustrates examples of the distortions corrected by the invention;

FIG. 6 illustrates examples of the correction process of the invention; and

FIG. 7 illustrates a block diagram examples of the distortion correction process of the invention.

### DETAILED DESCRIPTION OF THE INVENTION

Preferred embodiments of the present invention are illustrated in the FIGUREs, like numerals being used to refer to like and corresponding parts of the various drawings.

The present invention generally relates to the field of entertainment lighting and more specifically to digital image lighting systems.

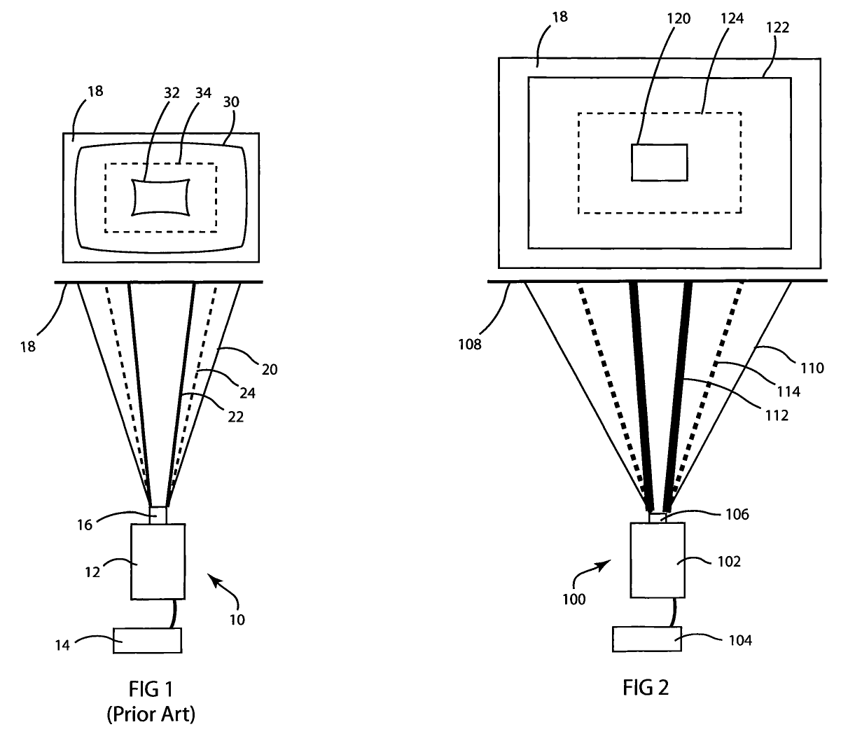

FIG. 1 illustrates a prior art digital luminaire system 10 showing a digital luminaire 12 projecting an image 30 on to screen 18. FIG. 1 illustrates orthogonal views of the projection surface/screen 18 in a single figure: the lower view showing the image generating beam axis and the upper view showing the image as seen along the light beam axis. The image 30 projected by the digital luminaire 12 is manipulated by media server 14. Media server 14 is here shown for clarity as external to the digital luminaire 12; however, media server 14 may be contained within the digital luminaire 12. FIG. 1 illustrates a luminaire 12 with a variable beam angle with wide angle 20 projecting a wider image 30 and narrow angle 22 projecting a smaller image 32 and a midrange angle 24 projecting a midrange image 34.

The luminaires 12 in these systems have lens systems 16 which attempt to optically minimize optical distortion when the lens is shifted from a narrow to wide beam angle. Therefore range of angles is kept pretty small typically a 1 to 1.5 range. Additionally, the lens system is designed so that the distortion is minimized in the middle of the range 24 image 34. While some distortion is inevitable at the upper and lower ranges with pincushion distortion being commonly seen at narrow beam angles and barrel distortion at wide beam angles.

FIG. 2 illustrates an embodiment of an improved digital luminaire system 100. Like the prior art systems the improved system contains a digital luminaire 102 that projects an image 120 on a projection surface 108. The system also includes a media server 104 which may be incorporated in the luminaire 102 or external to the luminaire 102. However this luminaire incorporates a lower cost lens system that is selected or designed ambivalent to the optical image distortion caused by the lens system. Because the less importance can be placed on the optical image distortion caused by the lens system, it is possible to use more efficient higher output light beams while at the same time getting greater beam angles. Although the lens selection places less importance to optical distortion, the images generated 120, 122, 124 across the range of beam angles 110, 112, 114 appear rectilinear or undistorted. Before proceeding with how this is accomplished, consider other implementations/embodiments of the present system.

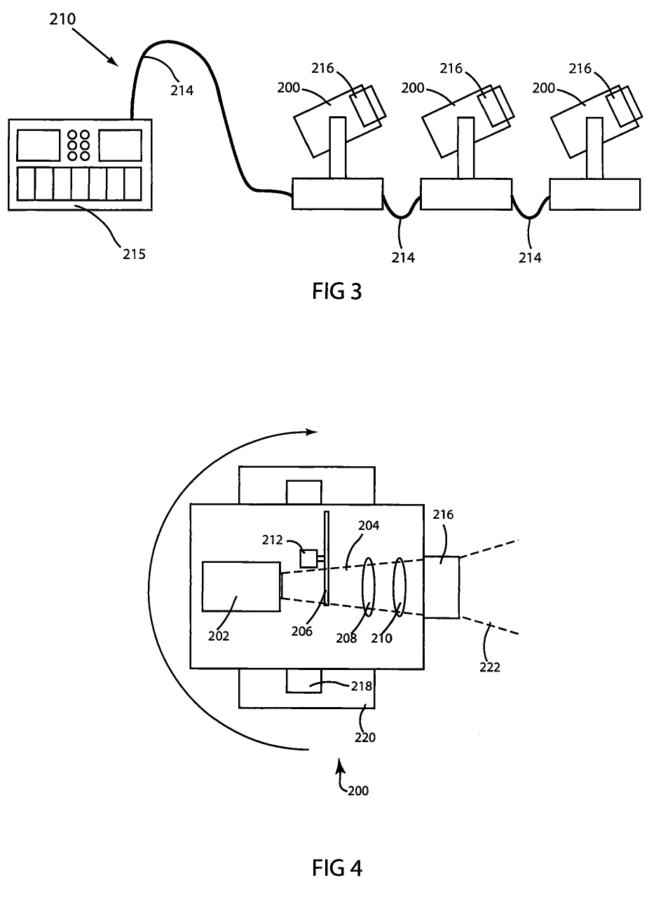

FIG. 3 illustrates a lighting system 210 utilizing an embodiment of the invention. Lighting control desk 215 connects to a plurality of digital luminaires 200 through a data link 214. Data link 214 may be an RS485 control signal utilizing data protocols such as DMX512 protocol, Artnet, RDM, ACN, an Ethernet connection or any other data transmission system as known in the art. Each digital luminaire 200 may contain a zoom lens 216 comprising a plurality of optical elements. The position of some or all of these optical elements may be controlled by control desk 215 through data link 214 so as to alter the optical properties including the focal length of zoom lens 212 so as to alter the beam angle of the projected image and the position of lens elements to provide focus adjustment. In these systems 210, the media server illustrated in FIG. 2 may be incorporated in the control desk 215 and service one or more luminaires 200. In other embodiments the media server(s) may be incorporated in one or more of the luminaires 210 and may service just the luminaire in which it is incorporated or multiple luminaires. It is important for the functioning of a real time image distortion correction embodiment of the present system that the media server that is serving a particular luminaire receive information from that luminaire as to the beam angle and or lens position(s) setting for that luminaire when the image to be corrected will be projected if the distortion changes for different settings.

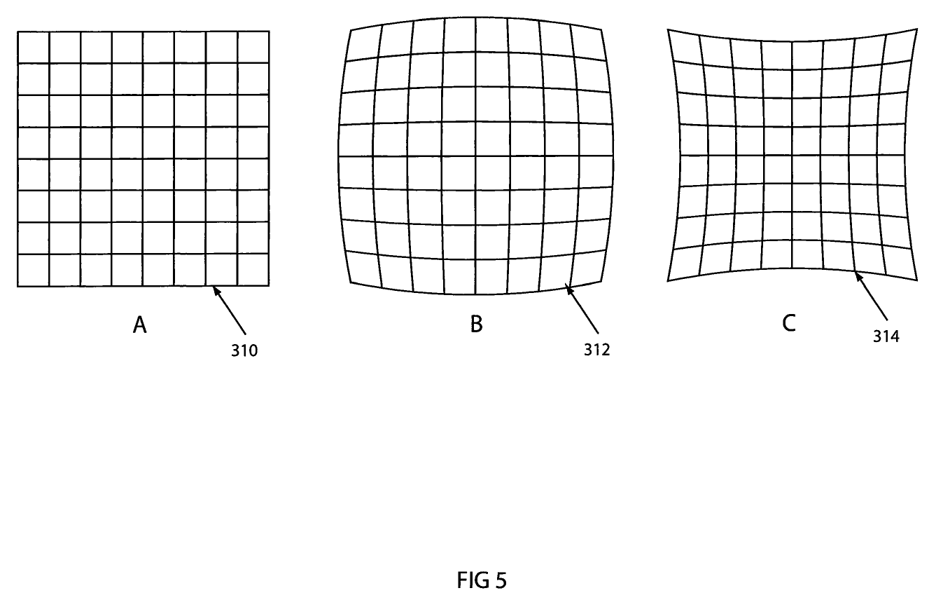

FIG. 4 illustrates an example of such a luminaire 200. Digital luminaire 200 contains an imaging light source 202. Imaging light source 202 may comprise a video projector light source utilizing, but not limited to, a liquid crystal display (LCD), digital micro mirror device (DMD) or other light valve image-producing device as well known in the art. The light beam 204 produced by imaging light source 202 may pass through beam modulating devices such as an image filters 206 and lens elements 208 and 210 before exiting through final lens element 216 as output beam 222. Together or in various combinations these elements may make up an optical lens drive. Lens elements 208, 210 and 216 may be moved as required through actuators (not shown) so as to effect a change in focus and, if the elements constitute a zoom lens, then a change in the angle of the output beam 222. Such actuators may be stepper motors, servo motors, solenoids or other actuator as well known in the art. All actuators may be either locally or remotely controlled.

The digital luminaire may be mounted on a pan and tilt yoke 218 connected to a fixed support or platform 220 allowing the motion in two orthogonal axes of the entire image producing chain.

It is often desirable for the operation of a digital luminaire to have as wide a range of beam angles as possible available from either fixed focal length or zoom lenses. However, increasing that range often leads to greater more undesirable distortions in the image. In optical terms a distortion or aberration is a deviation from rectilinear projection, a projection in which straight lines in an input image remain straight and in the same relationship in the projected image. Although distortion can be irregular or follow many patterns, the most commonly encountered distortions are approximately radially symmetric arising from the radial symmetry of the projections lens system. These radial distortions can usually be classified as one of two main types:

Barrel distortion, in which image magnification decreases with distance from the optical axis. The apparent effect is that of an image which has been mapped around a sphere. This effect is often seen in very short focal length lenses (wide beam angle).

Pincushion distortion, in which image magnification increases with the distance from the optical axis. The visible effect is that lines that do not go through the centre of the image are bowed inwards, towards the centre of the image. This effect is often seen in long focal length lenses (narrow beam angle).

An example of each is shown in FIG. 1 with image 30 illustrating a pincushion and image 32 illustrating a barrel distortion. As previously discussed, both these distortions can be corrected/avoided through complex, and typically expensive, optical systems often with a corresponding increase in the number of optical elements or lenses. However, such systems are often less efficient and allow less light to pass into the final image. They are also often larger and heavier and would necessitate the actuator system used to automate their movement and control becoming stronger and more complex.

FIG. 5 illustrates the most common distortions that may be produced. In FIG. 5A, grid 310 shows the input image as an evenly spaced square grid. In an ideal system this image would pass through the system with no distortions or changes. FIG. 5B shows the same image after barrel distortion has been introduced by the optical system as grid 312 and FIG. 5C shows the same image after pincushion distortion has been introduced by the optical system as grid 314.

As embodied herein the present invention advantageously allows the use of simple designs for both fixed focal length lenses and wide range zoom lenses which are optimized to be efficient and inexpensive to manufacture without concern for the consequent optical distortions which will be introduced by the optical system. To compensate for these distortions opposing and opposite distortions algorithms are stored and are applied to the source image by the media server before projecting the image. The media server may comprise a digital signal process, computer or other device well known in the art capable of modifying digital imagery. Such devices may already be used to apply such effects as rotations and scaling to the image.

Optical lens systems cause discernable optical distortions. In most cases these distortions take the form of discernable patterns (like the barrel and pincushion patterns described above) which can be measured and or modeled. These models can be found in lens design software packages. Once the measurements or model of the distortion pattern is known creating a counteracting pattern or algorithms can be accomplished by a person reasonably skilled in the art of lens design and digital image manipulation.

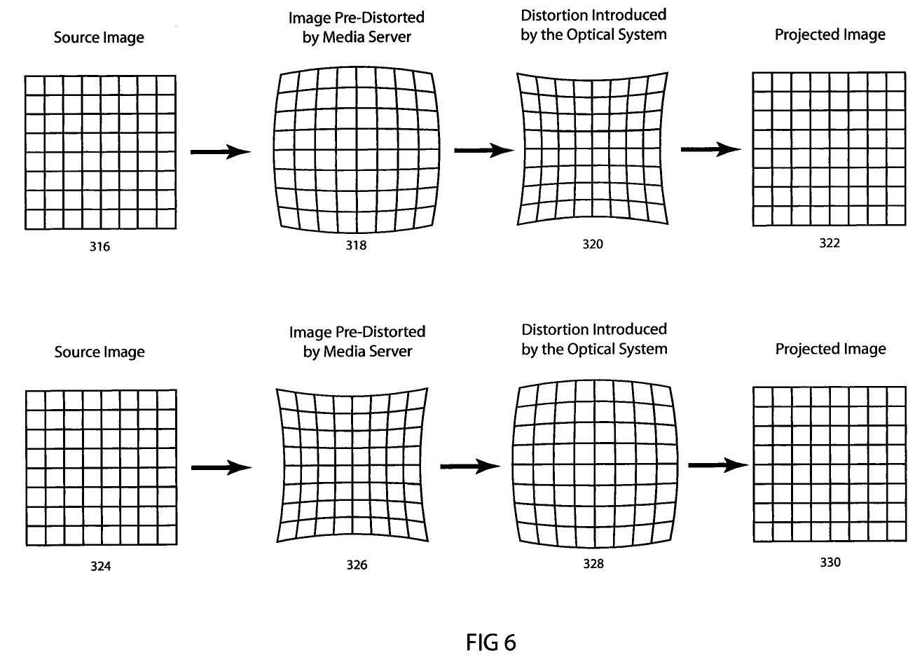

FIG. 6 diagrammatically illustrates the distortion correction mechanism of an embodiment of the invention. A source image 316 which has no rectilinear distortion is pre-distorted 318 by a media server to an image exhibiting barrel rectilinear distortion. Subsequently the image undergoes pincushion rectilinear distortion 320 within the optical system which counteracts the pre-distortion so that the projected image returns to its original rectilinear projection 322. Similarly, source image 324 which has no rectilinear distortion is deliberately pre-distorted 326 by a media server to an image exhibiting pincushion rectilinear distortion. Subsequently the image undergoes barrel rectilinear distortion 328 within the optical system which corrects the image back to its original rectilinear projection 330.

In further embodiments of the invention the system is capable of correcting the distortions introduced by optical systems that exhibit more complex optical distortions. In particular a variable focal length zoom lens may exhibit barrel distortion at some beam angles in its range and pincushion distortion at other beam angles. The distortion type and amount introduced by the lens at every position in its zoom range may be measured and stored within the system during the design or manufacturing process or an update process. The system may subsequently utilize that data along with the known current position and beam angle of the zoom lens so as to dynamically adjust the pre-distortion applied to the image in the media server such that it is always equal and opposite to the optical distortion introduced by the lens at that beam angle.

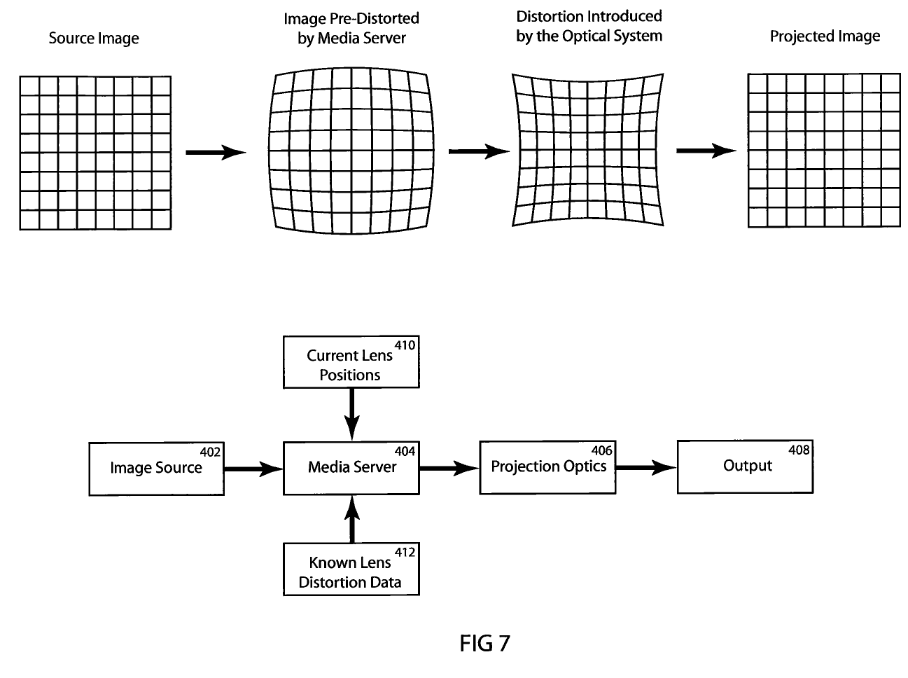

FIG. 7 illustrates a block diagram of the process. An image source 402 provides an image. Image source 402 could be internal to the media server itself, an external video source, a further media player, a memory playback system a computer or other means of generating an image as well known in the art. The image is provided to media server 404 as an input. Media server 404 is also provided with information as to the current position of the optical elements comprising the lens system or optical drive 410 and data on the distortions introduced by those optical elements at all positions of focus and focal length 412 which would preferably be locally stored. Using this information the media server calculates the amount and type of pre-distortion needed to counteract the optical distortion and applies it to the input image. This pre-distorted image is then passed to the projection system and optics 406. Projection optics 406 will then project the image while introducing the known optical distortion such that the final image output 408 is substantially identical to the image provided by the image source 402.

In yet further embodiments other forms of optical distortion may be compensated for in the same manner by pre-distorting the image with an equal and opposite distortion to that introduced by the optical system. Such distortions may be complex and comprise a plurality of different distortions applied simultaneously. Although barrel and pincushion rectilinear distortions are discussed herein the invention is not so limited and the disclosed system may be used to compensate for any other types of optical distortion introduced by the projection lens system.

The disclosed invention provides an enhanced system such that a lens may be constructed with improved beam angle control while maintaining high efficiency and low complexity. The lens may be a fixed focal length lens or a variable focal length zoom lens and can be designed or chosen giving more importance to efficiency and range rather than being limited to concerns related to optical distortion of the system since most any distortion could be corrected by predistorting the image projected to the lens system.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

What is claimed is:

1. A digital luminaire comprised of:
an imaging light source which can receive digital image data which employs a zoom optical lens which optically distorts images processed through it in a discernable pincushion and/or barrel pattern(s) that varies across a zoom range of the optical lens drive;
a media server for processing digital images fed to the digital light beam engine together with information related to the zoom range position of the optical lens and stored predistortion algorithm to predistort the digital image to counteract the optical distortion caused by the optical lens.

2. A digital luminaire comprised of:
a imaging light source which can receive digital image data which employs an optical lens which optically distorts images processed through it in a discernable pattern;
a processor for processing digital images fed to the digital light beam engine which applies a stored predistortion algorithm to the digital image to counteract the optical distortion caused by the optical lens.

3. A digital luminaire projection system of claim 2 where the discernable optical distortion pattern is a pincushion pattern.

4. A digital luminaire projection system of claim 3 where the stored predistortion pattern optical distortion algorithm models a pincushion pattern.

5. A digital luminaire projection system of claim 2 where the discernable optical distortion pattern is a barrel pattern.

6. A digital luminaire projection system of claim 5 where the stored predistortion pattern optical distortion algorithm models a barrel pattern.

7. A digital luminaire projection system of claim 2 where the stored predistortion pattern optical distortion algorithm models a pattern other than a barrel pattern or pincushion pattern.

8. A digital luminaire projection system of claim 2 wherein:
optical lens includes a zoom functionality that modifies the beam angle of the digital luminaire's output across a zoom range and the optical distortion pattern of the optical lens varies across the zoom range.

9. A digital luminaire projection system of claim 8 wherein:
the zoom position of the optical lens is provided to the digital image processor and
the digital image processor uses the zoom position in its application of stored predistortion algorithms to counteract the distortion caused by the optical lens drive.

10. A digital luminaire projection system comprising of:
a imaging light source which can receive digital image data which employ an optical lens which optically distorts images processed through it in a discernable pattern;
a media server for processing digital images fed to the digital light beam engine which applies a stored predistortion algorithm to the digital image to counteract the optical distortion caused by the optical lens.

11. A digital luminaire projection system of claim 10 where the discernable optical distortion pattern is a pincushion pattern.

12. A digital luminaire projection system of claim 11 where the stored predistortion pattern optical distortion algorithm models a pincushion pattern.

12. A digital luminaire projection system of claim 10 where the discernable optical distortion pattern is a barrel pattern.

13. A digital luminaire projection system of claim 12 where the stored predistortion pattern optical distortion algorithm models a barrel pattern.

14. A digital luminaire projection system of claim 10 where the stored predistortion pattern optical distortion algorithm models a pattern other than a barrel pattern or pincushion pattern.

15. A digital luminaire projection system of claim 10 where the light imaging source and media server are incorporated in the same unit.

16. A digital luminaire projection system of claim 15 where the media server can serve multiple luminaires.

17. A digital luminaire projection system of claim 10 where the light imaging source and media server are incorporated in separate units.

18. A digital luminaire projection system of claim 17 where the media server can serve multiple luminaires.
